(19) United States
(12) Patent Application Publication
(10) Pub. No.: US 2008/0320132 A1
(43) Pub. Date: Dec. 25, 2008

(54) METHOD FOR COMMUNICATION WITH INTERCEPTION OF CONTROL MESSAGES

(75) Inventors: Arnaud GONGUET, Paris (FR); Vincent Verdot, Montlhery (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/145,019

(22) Filed: Jun. 24, 2008

(30) Foreign Application Priority Data
Jun. 25, 2007 (FR) 0704525

(51) Int. Cl. G06F 15/173

(52) U.S. Cl. 709/224

(57) ABSTRACT

A connection-oriented communication method between at least two communicating entities, to with a sending entity and a recipient entity connected via a telecommunication network said method comprising the following steps:
the sending, by the sending entity, of a data flow, in the form of packets, intended for the recipient entity;
the receiving of the data by an proxy application server placed between the entities,
the interception by the proxy server of any control messages regarding quality of service which have been defined as potentially affecting the working order of the recipient entity,
the transmission, by the proxy server to the recipient entity, of the data arriving from the sending entity regardless of the quality of service.

The invention pertains to the field of telecommunications.

Telecommunications have tended to evolve towards all-IP, i.e. exchanging all multimedia data using Internet Protocol, commonly abbreviated IP. In IP, the digitized data, whether it is multimedia data (images, sound, video) or voice data (generally for telephone applications) are made up of IP packets placed in frames and then transmitted over the network, whether it is a local are network (LAN), metropolitan area network (MAN), or wide area network (WAN).

Communication between two communicating entities may be conducted using two types of dialogue: connectionless-oriented and connection-oriented.

In connectionless-oriented, the packets are transmitted by the sending entity without said entity having previously verified whether the receiving entity is present on the network.

In connection-oriented, the entities, prior to transmitting the data itself, conduct a negotiation phase during which the connection is established. After the connection has been established, the data is exchanged. Then, once the exchange of data has completed, the connection becomes free. At the time the connection is opened, the entities may additionally negotiate the quality of service, or QoS, for which parameters defining the permissible limits of the communication are exchanged between the entities.

One currently popular network architecture offers an adequate framework for multimedia communication between communicating entities in connection-oriented mode: IMS (IP Multimedia Subsystem), developed by the 3GPP consortium (Third Generation Partnership Project).

To establish, modify, and terminate the communication sessions, as well as to perform authentication, IMS uses the protocol known as SIP (Session Initiation Protocol).

In the session level of the protocol stack of datagrams exchanged between two network entities, the most commonly used communication protocol today is the one known as RTP (Realtime Transport Protocol), used in combination with the one known as UDP (User Datagram Protocol), which is used in message level of the stack.

These two protocols are associated with control protocols, used whenever the network encounters problems affecting communication between the entities: routing problems, disconnection problems for one or more entities, or a network breakdown.

In the session level, the control protocol associated with the RTP protocol is the RTCP protocol (Realtime Transport Control Protocol), one essential function of which is to inform the communicating entities of the quality of service. In the message level, the commonly used control protocol, associated with the UDP, is the ICMP protocol (Internet Control Message Protocol).

In practice, communication between two entities in connection-oriented mode involves:
opening an application (in the software level) intended to ensure the playing of the data (on the screen and/or through the loudspeakers) contained within the packets. This application may be the entity itself, when this term is used in the software sense, or it may be a software application implemented on a processor of the entity when this term is used in a hardware sense to designate a communicating device (SoftPhone, communicating PDA, etc.);
opening a connection in an integrated communication interface (in a hardware sense) or an interface associated (in a software sense) with the entity.

In one conventional operating mode, whenever the network or an entity encounters problems (breakdowns or disruptions in the network, poorly handled handovers in mobile networks, etc.), the data packets exchanged may be incomplete or missing. In certain nodes of the network, the detecting of this fault generates control messages addressed to the recipient entity, intended to inform it of the degradation in the quality of service. As quality of service is considered a priority in current network policies, the acceptance of these control messages by the application generally leads to its immediate or delayed closing, correlated with the need, when the connection is restored or repaired, to reopen the application, going through all of the steps prior to reading the data: authentication, etc.

The result is a loss of time—and data—for the user.

The invention is meant to perfect existing networks, notably by remedying the abovementioned problems.

To that end, the invention discloses a communication method as defined in the claims.

Other characteristics and advantages of the invention shall become more apparent upon examining the description below, and the attached drawings, in which:

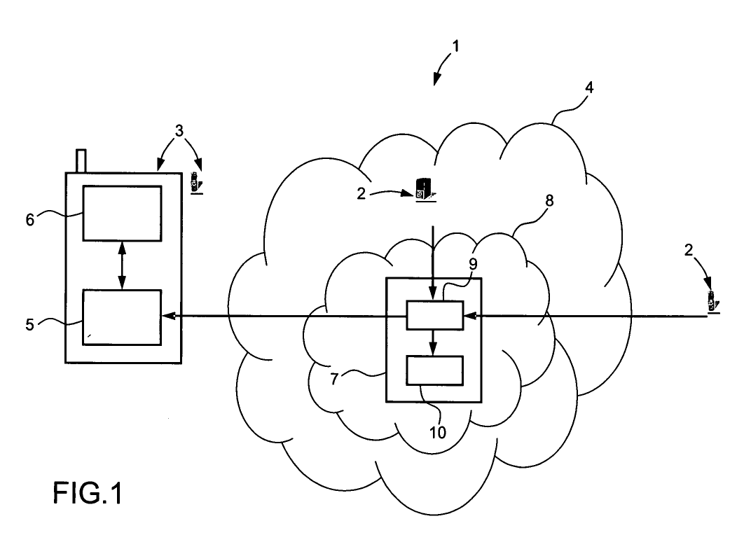

FIG. 1 is a schematic view showing a network architecture enabling the implementation of a communication method of the invention;

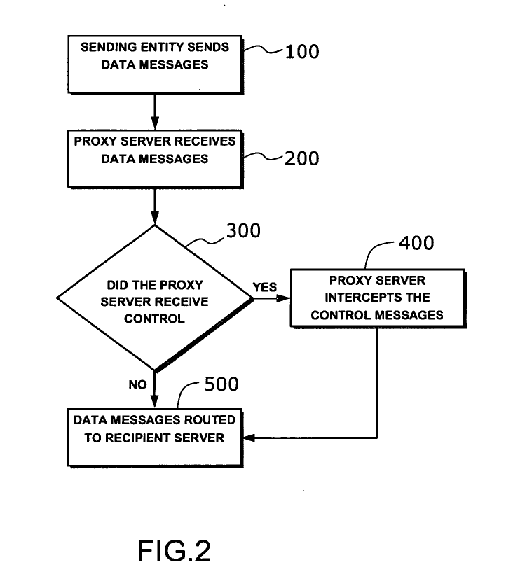

FIG. 2 is a diagram showing various steps of a communication method of the invention;

FIG. 1 depicts a network architecture 1 comprising at least two communicating entities 2, 3 in the form of fixed devices (such as a computer equipped with voice-over-IP software or an IP telephone) or mobile devices (a cellular telephone, communicating PDA or Smartphone), connected via a local area network (LAN), metropolitan area network (MAN), or wide area network (WAN) 4, such as the Internet.

Each entity 2, 3 comprises a communication interface 5 capable of establishing a connection with the network 4 and handling the communication exchanged using IP, and a software application 6 that can play the data contained in the form of packets in the messages exchanged over the network 4.

The communication interface 5 and the application 6 are, within each entity 2, 3, configured to handle data exchange protocols in connection-oriented mode, particularly RTP.

When communication is established between two entities 2, 3 (naturally, communication between a number of entities greater than two may be provided for), a sending entity 2 sends a data flow in the form of packets to a receiving entity 3.

The receiving entity 3 is connected to a proxy server 7 integrated into a core network 8—particularly an IMS network—implemented within the network 4, and through which the messages transmitted to the receiving entity 3 travel.

The proxy server 7 includes two functional modules, to with:
a filter module 9 capable of detecting, within the data flows traveling through the server 7, ICMP control messages (in the message level) or RTCP (in the session level) including the information related to the quality of service;
a capture module 10, towards which any control messages are routed.

Such control messages are included in the data flows traveling on the network 4 to the recipient entity 3, as soon as problems are detected within the network 4 (for example, in a gateway), affecting either the connection itself (breakdown or unavailability of the network), or the quality of the data transmitted (for example, packet loss). It should be noted that the notion of quality of service (QoS) is meant to qualify this type of problem.

The architecture 1 described above makes it possible to organize communication between at least two entities 2, 3, to with a sending entity 2 and a recipient entity 3, in the following manner.

A first step 100 consists of the sending entity 2 sending a data flow (images, sound, video, voice) in the form of packets included within an IP frame, intended for the recipient entity 3.

A second step 200 consists of the proxy server 7 receiving the data sent by the sending entity 2.

A third step 300 consists of the proxy server 7 examining the data using the filter module 9 in both the message and session levels of the frames in order to respectively detect ICMP or RTCP control messages, related to the quality of service.

A fourth step 400 consists of the proxy server 7, and more precisely the filter module 9, once control messages have been detected by said filter module, intercepting these messages and routing them to the capture module 10, where they are stored—or destroyed—without being transmitted to the recipient entity 3 whenever these messages are defined as potentially affecting the working order of the application.

It is possible to configure the filter module 9 to:
either intercept all control messages, if it is assumed that any message of this type may affect the working order of the application 6 (and therefore the recipient entity 3), i.e. cause it to close, or at least cause a malfunction therein,
or to intercept only a predetermined category of control messages, defined as those that may affect the working order of the application 6 (and therefore the recipient entity 3), with the other control messages, defined as harmless to the application, being transmitted.

In practice, this configuration is performed by a network administrator.

For the data flow sent by the sending entity 2 a fifth step 500 consists of the proxy server 7, and more precisely its filter module 9, sending anything whatsoever to the recipient entity 3, regardless of the quality of service—i.e, from the viewpoint of the data, whether or not the packets transmitted are complete, and from the viewpoint of the proxy server 7, whether or not the control messages were intercepted.

In practice, because the RTP and RTCP flows are generally treated by different ports, the data flows (in RTP mode) do not necessarily travel through the filter module 9, which is preferentially linked only to the RTCP port.

In this manner, the application 6 is kept open no matter what the quality of service is, and in particular, no matter what the status of the network 4 or connection is. In particular, if the network 4 is disrupted (this is a common occurrence in cellular telephone networks whenever a telephone loses the network, such as due to an obstacle placed within the air interface, such as a tunnel), it is not necessary to reopen the application 6—by going through the preliminary phases comprising, for example, the authentication step—once the network 4 is restored. Though such a functionality goes against the current trend that favors quality of service above all else, it does make it possible for users to save precious time.

We have seen that the term “entity” may cover not only any communicating device, as described above, but also any software application that may receive data from the network. Furthermore, it should be noted that, as is depicted in FIG. 1, the sending entity 2 may be a server, such as a media server.

The fact that the proxy server 7 is, in the foregoing description, incorporated into an IMS network core is a particular, non-limiting example. Such a server 7 may be incorporated into another type of network, particularly within a local area network of an Internet service provider, and providing, for example, video services that are streamed, i.e. distributed live or with a short delay (as opposed to downloading).

1. A connection-oriented communication method between at least two communicating entities (2, 3) to with a sending entity (2) and a recipient entity (3) connected via a telecommunication network (4) said method comprising the following steps:
the sending, by the sending entity (2), of a data flow, in the form of packets, intended for the recipient (3) entity;
the receiving of the data by an proxy application server (7) placed between the entities (2, 3),
the interception by the proxy server (7) of any control messages regarding quality of service which have been defined as potentially affecting the working order of the recipient entity (3),
the transmission, by the proxy server (7) to the recipient entity (3), of the data arriving from the sending entity (2) regardless of the quality of service.

2. A method according to claim 1, wherein the intercepted control messages are not transmitted by the server (7) to the recipient entity (3).

3. A method according to claim 1, wherein the proxy server (7) intercepts all control messages regarding quality of service.

4. A method according to claim 1, wherein the proxy server (7) intercepts a predetermined category of control messages, defined as potentially affecting the working order of the recipient entity (3).

5. A method according to claim 1, wherein the control messages are established in accordance with the RTCP protocol.

6. A method according to claim 1, wherein the control messages are established in accordance with the ICMP protocol.

7. A communication system operating in connection-oriented mode, comprising a proxy application server (7) configured to:
receive a data flow arriving from a sending communicating entity (2), intended for a recipient communicating entity (3) connected to the sending entity (2) via the telecommunications network (4),
intercept any control message regarding quality of service, defined as potentially affecting the working order of the recipient entity (3),
transmitting the data flow to the recipient entity (3), regardless of the quality of service.

8. A system according to claim 7, wherein the proxy application server (7) is configured to not transmit the intercepted control messages to the recipient entity (3).

9. A computer program product implemented on a processor, and comprising instructions to:
receive, in connection-oriented mode, a data flow arriving from a sending communicating entity (2), intended for a recipient communicating entity (3) connected to the sending entity (2) via the telecommunications network (4),
intercept any control message regarding the quality of service which may potentially affect the working order of the recipient entity (3),
transmit the data flow to the recipient entity (3) regardless of the quality of service, without transmitting the intercepted control messages.

10. A computer program product according to claim 9, comprising instructions to not transmit the intercepted control messages to the recipient entity (3).
